(19) United States
(12) Patent Application Publication
(10) Pub. No.: US 2026/0280775 A1
(43) Pub. Date: Sep. 17, 2026

(54) TRANSPORT BLOCK IDENTIFIER

(71) Applicant: Nokia Technologies Oy, Espoo (FI)

(72) Inventors: Ping Ping WEN, Shanghai (CN); Ping YUAN, Beijing (CN); Tzu-Chung HSIEH, Hoffman Estates, IL (US); Jing Yuan SUN, Beijing (CN)

(73) Assignee: Nokia Technologies Oy, Espoo (FI)

(21) Appl. No.: 19/473,186

(22) PCT Filed: Apr. 7, 2023
(86) PCT No.: PCT/CN2023/087051

§ 371 Date: Oct. 7, 2025

(51) Int. Cl. H04L 1/1829; H04L 1/1812

(52) U.S. Cl. CPC H04L 1/1861; H04L 1/1816

(57) ABSTRACT

According to some example embodiments of the present disclosure, there is provided a solution for Hybrid Automatic Repeat reQuest (HARQ) retransmission indication. In the solution, the terminal device receives, from the network device, downlink control information (DCI) comprising a transport block (TB) identifier. The terminal device compares the received TB identifier with a stored TB identifier. Then, the terminal device processes data based on a result of the comparison. The data comprise uplink data to be transmitted based on an uplink grant comprised in the DCI or downlink data received based on a downlink assignment comprised in the DCI.

### FIELDS

Various example embodiments of the present disclosure generally relate to the field of telecommunication and in particular, to methods, devices, apparatuses and computer readable storage medium for Hybrid Automatic Repeat reQuest (HARQ) retransmission indication.

### BACKGROUND

HARQ may be implemented in the Medium Access Control (MAC) protocol of Long Term Evolution (LTE) and fifth generation (5G) New Radio (NR). HARQ is a transmission scheme to improve reliability and robustness by providing retransmission and by using different code redundancy versions (RVs) and incremental soft combining. For both downlink and uplink, depending on the capability of User Equipment (UE), multiple HARQ processes may run in parallel. In the case of downlink (DL) data transmission, the UE sends HARQ feedback (for example, Acknowledgement, ACK, or Negative-Acknowledgement, NACK) to report decoding outcome of the Transport Block (TB) received in a HARQ process. Based on the feedback, the network (NW) may retransmit the previous TB or transmit a new TB for the same HARQ process. In the case of UL data transmission, NW may schedule a new TB or retransmission based on the decoding status of previous transmission in a HARQ process.

### SUMMARY

In a first aspect of the present disclosure, there is provided an apparatus. The apparatus comprises at least one processor; and at least one memory storing instructions that, when executed by the at least one processor, cause the apparatus at least to: receive, from a network device, downlink control information (DCI) comprising a transport block identifier; compare the transport block identifier with a stored transport block identifier; and process data based on a result of the comparison, wherein the data comprise uplink data to be transmitted based on an uplink grant comprised in the downlink control information or downlink data to be received based on a downlink assignment comprised in the downlink control information.

In a second aspect of the present disclosure, there is provided an apparatus. The apparatus comprises at least one processor; and at least one memory storing instructions that, when executed by the at least one processor, cause the apparatus at least to: determine a transport block identifier corresponding to a transport block; transmit, to a terminal device, downlink control information comprising the transport block identifier; and transmit downlink data of the transport block to the terminal device based on the downlink control information, or receive uplink data of the transport block from the terminal device based on the downlink control information.

In a third aspect of the present disclosure, there is provided a method. The method comprises, receiving, at a terminal device from a network device, downlink control information comprising a transport block identifier; compare the transport block identifier with a stored transport block identifier; and process data based on a result of the comparison, wherein the data comprise uplink data to be transmitted based on an uplink grant comprised in the downlink control information or downlink data to be received based on a downlink assignment comprised in the downlink control information.

In a fourth aspect of the present disclosure, there is provided a method. The method comprises: determining, at a network device, a transport block identifier corresponding to a transport block; transmitting, to a terminal device, downlink control information comprising the transport block identifier; and transmitting downlink data of the transport block to the terminal device based on the downlink control information, or receiving uplink data of the transport block from the terminal device based on the downlink control information.

In a fifth aspect of the present disclosure, there is provided an apparatus. The apparatus comprises means for receiving, from a network device, downlink control information comprising a transport block identifier; means for comparing the transport block identifier with a stored transport block identifier; and means for processing data based on a result of the comparison, wherein the data comprise uplink data to be transmitted based on an uplink grant comprised in the downlink control information or downlink data to be received based on a downlink assignment comprised in the downlink control information.

In a sixth aspect of the present disclosure, there is provided an apparatus. The apparatus comprises means for determining a transport block identifier corresponding to a transport block; means for transmitting, to a terminal device, downlink control information comprising the transport block identifier; and means for transmitting downlink data of the transport block to the terminal device based on the downlink control information, or means for receiving uplink data of the transport block from the terminal device based on the downlink control information.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates shows a signaling chart for communication according to some example embodiments of the present disclosure;

FIG. 3 illustrates an example process for HARQ feedback at a terminal device according to some example embodiments of the present disclosure;

FIG. 4 illustrates a flowchart of a method implemented at a terminal device according to some example embodiments of the present disclosure;

FIG. 5 illustrates a flowchart of a method implemented at a network device according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “new transmission” may refer to an initial transmission of a TB. In the following, the terms “new transmission” and “initial transmission” may be used interchangeably.

As used herein, if an TB identifier corresponds to another TB identifier, it may mean that the two TB identifiers may have the same value, or that the two TB identifiers are equal to each other, or that one of the two TB identifiers is mapped to the other, or the like. In one simple example, received and stored TB identifiers may be understood to correspond to each other if they have the same value. Further, TB identifiers may be understood to correspond to each other if they identify the same TB. Similarly, two TB identifiers may be understood to not correspond to each other in opposite cases (e.g. have different values, are not equal to each other and/or are not mapped to each other). Further, TB identifiers may be understood to not correspond to each other if they identify different TBs.

As used herein, if a new data indicator (NDI) corresponds to another NDI, it may mean that the two NDIs may have the same value, or that the two NDIs are equal to each other, or that one of the two NDIs is mapped to the other, or the like.

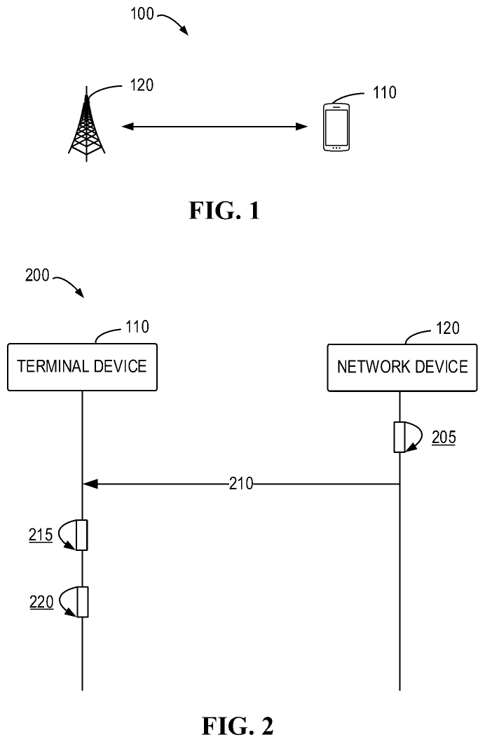

FIG. 1 illustrates an example communication environment 100 in which example embodiments of the present disclosure can be implemented. The communication environment 100 may include a terminal device 110. Hereinafter the terminal device 110 may also be referred to as a UE.

The communication environment 100 may further include a network device 120. Hereinafter the network device 120 may also be referred to as a gNB. The network device 120 may communicate with the terminal device 110.

It is to be understood that the number of network devices and terminal devices shown in FIG. 1 is given for the purpose of illustration without suggesting any limitations. The communication environment 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Data transmission between the terminal device 110 and the network device 120 may be based on the HARQ scheme. In some example embodiments, non-terrestrial communication may be employed in the communication environment 100.

Non-terrestrial communication can be in a complementary manner to terrestrial deployments where satellite connectivity can provide coverage beyond terrestrial deployments. The 3rd Generation Partnership Project (3GPP) has studied non-terrestrial networks (NTN) for Release (Rel)-17 and Internet of Things (IoT)-NTN performance enhancements for Rel-18. HARQ feedback enabled/disabled in downlink and HARQ mode A/B in uplink are important features. The benefit of disabling HARQ feedback in downlink and HARQ mode B in uplink for NTN and IoT over NTN is to enable the gNB to reuse a HARQ process ID before a full HARQ Round-Trip Time (RTT) has elapsed to avoid the HARQ stalling and reduce the transmission latency as well as enable peak throughput.

In NR NTN, disabling/enabling HARQ feedback for downlink transmission or HARQ mode A/B for uplink transmission is semi-statically configured by RRC signaling. The configuration is indicated per HARQ process index in a bitmap manner, e.g., 32-bit bitmap if the configured harq process number is 32.

In IoT over NTN, the discussion on HARQ feedback disabling/enabling in downlink and HARQ mode A/B in uplink is ongoing. Both HARQ feedback enabling and disabling was agreed to be supported in downlink to guarantee the reliability of some important MAC control element (CE) and radio resource control (RRC) signaling as well as avoid HARQ stalling. Due to the number of HARQ processes in IoT and eMTC may be smaller than the NR UE, e.g., at most two HARQ processes for NB-IoT, 4 HARQ processes for eMTC CE mode B, there may need large signaling on reconfiguration HARQ feedback enabling/disabling if re-using the NR NTN solution. Therefore, dynamic HARQ feedback enabling/disabling is discussed for IoT over NTN. It has been agreed to support both option 1 (i.e., per HARQ process via UE specific RRC signaling in a semi-static way) and option 3 (i.e., explicitly indicated by DCI dynamically) for NB-IoT and eMTC CE mode B, but to support option 1 (i.e., per HARQ process via UE specific RRC signaling) for eMTC CE mode A. The detailed solution on how to use option 1 and option 3 is still in discussion. Furthermore, HARQ mode A and HARQ mode B are agreed to be supported in uplink for IoT NTN. In HARQ mode A, scheduling of a UL retransmission always depends on previous PUSCH decoding result. Whereas in HARQ mode B, the retransmission is scheduled without depending on the decoding results. The detailed solution on HARQ mode A/B is also in discussion. In the downlink, the eNB/gNB performs the scheduling of the new transmission and retransmission of each transport block (TB) per HARQ process based on the HARQ feedback from the UE. The NDI fields in DCI are used to indicate the scheduling assignment is for new transmission and retransmission. At the UE side, the detailed procedure for HARQ operation may be as below:

For each transmission time interval (TTI) where a transmission takes place for the HARQ process, one or two (in case of downlink spatial multiplexing) TBs and the associated HARQ information are received from the HARQ entity.

For each received TB and associated HARQ information, the HARQ process shall:
if the NDI, when provided, has been toggled compared to the value of the previously received transmission corresponding to this TB; or
if this is the very first received transmission for this TB (i.e. there is no previous NDI for this TB):
   consider this transmission to be a new transmission.
else:
   consider this transmission to be a retransmission.

The MAC entity then shall:
if this is a new transmission:
   attempt to decode the received data.
else if this is a retransmission:
   if the data for this TB has not yet been successfully decoded:
      combine the received data with the data currently in the soft buffer for this TB and attempt to decode the combined data.
if the data which the MAC entity attempted to decode was successfully decoded for this TB; or
if the data for this TB was successfully decoded before:
   if this is the first successful decoding of the data for this TB:
      deliver the decoded MAC PDU to the disassembly and demultiplexing entity.
   generate a positive acknowledgement (ACK) of the data in this TB.
else:
   replace the data in the soft buffer for this TB with the data which the MAC entity attempted to decode.
   generate a negative acknowledgement (NACK) of the data in this TB.

The elaborate design of NDI fields in LTE and NR is to use toggled value instead of the absolute value to indicate the new transmission, which can detect the DCI/NDI failure and avoid the wrong combination of the data of different TBs. One example process can be as below.

At step 0: UE successfully receives DCI with NDI=0. The corresponding TB is TB0. The UE does not decode the corresponding PDSCH correctly, i.e., TB0 decoding failure. At step 1: gNB schedules a new transmission with NDI=1, and the corresponding TB is TB1. At step 2: UE misses the DCI with NDI=1. At step 3: gNB schedules retransmission with NDI=1, and the corresponding TB is TB1. At step 4: UE receives DCI with NDI=1, and the UE will know that the NDI is toggled, and the DCI is for another TB. Thus, the UE will not perform data combining for TB decoding.

But when HARQ feedback is disabled, the network and the UE cannot synchronize the NDI status when there are DCI decoding failures e.g., due to deep fading (as described in Step 2 below). It is very likely to occur that the network transmits one new transmission while the UE misunderstands it as a retransmission. In this case, there will be an error in the combining of received data for TB decoding (as described in Step 6 below). One example process below can show the issue in detail, where DL is taken as an example.

At step 0: UE successfully received DCI with NDI=0, and the corresponding TB is TB0. The UE does not decode the corresponding PDSCH correctly, i.e., TB0 decoding failure. At step 1: gNB schedules a new transmission with NDI=1, and the corresponding TB is TB1. At step 2: UE misses the DCI on a new transmission with NDI=1. At step 3: gNB schedules retransmission with NDI=1, and the corresponding TB is TB1. At step 4: UE still misses the DCI on retransmission with NDI=1. At step 5: gNB decides to schedule a new transmission with NDI=0, and the corresponding TB is TB2. At step 6: UE receives DCI with NDI=0 and performs corresponding PDSCH decoding. UE may combine TB0 data with TB2 data for the decoding, but this is an error case.

Similar problem is encountered in the UL, where a HARQ process can operate in HARQ mode A or HARQ mode B. The problem arises when a DCI for UL transmission is not detected by the UE for a HARQ process running in HARQ mode B. In that scenario, NDI states may be out of sync between the UE and network device. For example, the UE may perform a retransmission of the previous TB while the network device is expecting a new TB, or the UE may transmit a new TB while the network device is expecting a retransmission of the previous TB. Therefore, a more robust solution for retransmission indication is needed to avoid the combination error for downlink transmission when HARQ feedback is disabled in downlink and perform the correct encoding for HARQ initial transmission and retransmission for uplink transmission when HARQ mode B is enabled for uplink.

According to some example embodiments of the present disclosure, there is provided a solution for HARQ retransmission indication. In the solution, the terminal device receives from the network device DCI comprising a TB identifier. The terminal device compares the received TB identifier with a stored TB identifier. Then, the terminal device processes data based on a result of the comparison. The data comprise uplink data to be transmitted based on an uplink grant comprised in the DCI or downlink data received based on a downlink assignment comprised in the DCI.

In this disclosure, a new solution for retransmission indication is proposed. The proposed can be used for downlink transmission when the HARQ feedback is disabled and/or can be used for uplink transmission when HARQ mode B is enabled. With this solution, the terminal device can clearly interpret the indication on retransmission and perform the correct combination for HARQ retransmission for downlink transmission and the correct encoding for HARQ initial transmission and retransmission for uplink transmission. The solution can be applied to both NR NTN and IoT NTN.

Example embodiments of the present disclosure will be described in detail below with reference to the accompanying drawings.

Reference is now made to FIG. 2, which shows a signaling chart 200 for communication according to some example embodiments of the present disclosure. As shown in FIG. 2, the signaling chart 200 involves the terminal device 110 and the network device 120. For the purpose of discussion, reference is made to FIG. 1 to describe the signaling chart 200.

The network device 120 determines (205) a TB identifier corresponding to a TB. For UL transmission, the TB is to be received from the terminal device 110. For DL transmission, the TB is to be transmitted to the terminal device 110. In some example embodiments, the TB identifier may be per HARQ process. Accordingly, to determine the value of the TB identifier, the network device 120 may determine which HARQ process the TB corresponds to. Then based on the index or other information of the TB in the HARQ process, the network device 120 may determine the value of the TB identifier. In such example embodiments, TBs in different HARQ processes may have the same TB identifier. By maintaining or determining the TB identifier per HARQ process, the number of bits used for the TB identifier in DCI can be reduced.

In some example embodiments, for DL transmission, if HARQ feedback is disabled, the TB identifier may be used. In some example embodiments, for UL transmission, if HARQ mode B is enabled, the TB identifier may be used. In HARQ mode B, HARQ uplink retransmissions which is scheduled without depending on the decoding results by the network device 120. For example, retransmission may be scheduled before availability of initial transmission decoding result.

The TB identifier may be of any suitable form to identify the TB. For example, the TB identifier may be an index of the TB. In some example embodiments, the TB identifier may be a TB sequence number (SN) determined based on an index of the TB, and a maximum value of the TB SN.

For example, in DCI, a TB SN field may be introduced per HARQ process to indicate which TB the transmission/retransmission is for. The TB SN may have a value range of 0 to N−1 and only be updated when a new TB is transmitted. For the k-th TB to be transmitted in the HARQ process, the corresponding TB SN may be equal to mod(k, N), where k is the index of the TB, and (N−1) is the maximum value for the TB SN. The TB SN used for retransmission is the same as the TB SN used for the initial transmission of the same TB.

The network device 120 transmits (210), to the terminal device 110, DCI comprising the TB identifier. The DCI is associated with data corresponding to the TB. For UL transmission, the DCI may include an UL grant for the UL data to be transmitted by the terminal device 110. For DL transmission, the DCI may include a DL assignment for the DL data to be received by the terminal device 110.

In some example embodiments, one or more new fields may be defined in DCI to indicate the TB identifier. For example, the DCI may comprise one or more field used for the TB SN.

In some example embodiments, one or more existing field in the DCI may be re-used for the TB identifier. For example, for DL transmission, the TB identifier may be comprised in at least one field of: a field for indicating a HARQ-Acknowledgement (ACK) resource, (such as “HARQ-ACK resource” field), a field for indicating a HARQ-ACK resource offset (“HARQ-ACK resource offset” field), a field for a feedback timing indicator (such as “PDSCH-to-HARQ_feedback timing indicator”), or a field for a NDI.

For example, the current bits/fields in the DCI that indicate the HARQ feedback-related information (which is not used for HARQ feedback disabling) may be re-used as the SN fields.

In a first example option, the “HARQ-ACK resource” field in DCI format N1 may be re-used to represent a TB SN. A TB SN may be represented by the complete field or a subset of the field. For example, at most 4 bits in this field may represent 16 SN values. Two or three bits may also be used to represent 4 or 8 SN values. This option may be applied for Narrow Band Internet of Things (NB-IoT).

In a second example option, the “HARQ-ACK resource offset” field in DCI for DL assignment (e.g., Format 6-1A and Format 6-1B) may be re-used to represent a TB SN. A TB SN may be represented by a complete field. For example, 2 bits in this field represent 4 SN values (0,1,2,3,0,1,2,3). This option may be applied for eMTC Mode A and Mode B).

In a third example option, embodiment is that the “PDSCH-to-HARQ_feedback timing indicator” field in DCI for DL assignment (e.g., DCI format 1-0, DCI format 1-1,DCI format 1-2) may be re-used to represent a TB SN. A TB SN may be represented by a complete field or a subset of these fields. For example, at most 3 bits in this field represent 8 SN values. Two bits may also be used to represent 4 SN values. This option may be applied for NR NTN.

In a fourth example option, the NDI may be removed when HARQ feedback is disabled but the NDI field may be re-use as the SN field. For example, the 1 bit for NDI and some other bits (for example, those mentioned in the first, second, and third example options) may be used as the SN indication, in which the maximum value of SN may be doubled. In this case, the terminal device 110 may only track the SN for new transmission or retransmission but not depend on the NDI.

For UL transmission, one or more existing field in DCI may be re-used for the TB identifier SN. For example, the TB identifier may be comprised in a field for an NDI, similar to the fourth example option mentioned above.

In some example embodiments, which one or more fields in DCI are used to represent the TB identifier may be configured by the network device 120. In such example embodiments, the network device 120 may transmit to the terminal device 110 configuration information indicating which one or more fields are used to represent the TB identifier. The configuration information may be transmitted via any suitable signaling, for example, at least one of: a system information block (SIB), a RRC signaling, or an MAC CE. For example, the subset of the above fields which is re-used to represent the TB SN may be configured by the network device 120 via the SIB, the RRC signaling or the MAC CE.

Alternatively, in some example embodiments, which one or more fields in DCI are used to represent the TB identifier may be predefined in a technical specification. For example, the subset of the above fields which is re-used to represent the TB SN may be pre-defined in the technical specification.

Continuing with the signaling chart 200, the terminal device 110 receives the DCI comprising the TB identifier from the network device 120. Then, the terminal device 110 compares (215) the received TB identifier with a stored TB identifier. The stored TB identifier may be previously received from the network device 110 in previous DCI for the same HARQ process. In some example embodiments, the terminal device 110 may further store the received TB identifier.

The terminal device 110 processes (220) data based on a result of the comparison at 215. For UL transmission, the DCI may comprise UL grant and the processed data may be uplink data to be transmitted based on an UL grant. For DL transmission, the DCI may include a DL assignment and the processed data may be downlink data received based on the DL assignment.

In some example embodiments, the processed data may comprise the downlink data, in other words in the case of DL transmission. If the received TB identifier does not correspond to the stored TB identifier, the terminal device 110 may determine the downlink data to be an initial transmission of a TB corresponding to the received TB identifier. Accordingly, the terminal device 110 may decode the downlink data. If the terminal device 110 fails in decoding the downlink data, the downlink data may be stored for the TB corresponding to the received TB identifier.

In some example embodiments, in the case of DL transmission, if the received TB identifier corresponds to the stored TB identifier, the terminal device 110 may determine the downlink data to be a retransmission of a TB corresponding to the stored TB identifier. Accordingly, the terminal device 110 may combines the downlink data with stored data for the TB corresponding to the stored TB identifier, and decode the combined data.

In some example embodiments, the data may comprise the uplink data, or in other words in the case of UL transmission. If the received TB identifier does not correspond to the stored TB identifier, the terminal device 110 may determine the uplink data to be an initial transmission of a TB corresponding to the TB identifier. Accordingly, the terminal device 110 may encode the uplink data for the initial transmission, and transmits the encoded uplink data to the network device 120.

In some example embodiments, in the case of UL transmission, if the received TB identifier corresponds to the stored TB identifier, the terminal device 110 may determine the uplink data to be a retransmission of a TB corresponding to the stored TB identifier. Accordingly, the terminal device 110 may retransmit the uplink data to the network device 120.

In some example embodiments, the DCI received from the network device 120 may further comprises an NDI. In addition to the comparison between the received TB identifier and the stored TB identifier, the terminal device 110 may compare the received NDI with a stored NDI. The stored NDI may be received in previous DCI from the network device 120. If the received NDI corresponds to the stored NDI, the terminal device 110 may further compare the received TB identifier with the stored TB identifier, as described above. If the received NDI does not correspond to the stored NDI, the terminal device 110 may determine the processed data to be an initial transmission.

In other words, in the example embodiments where both the NDI and TB identifier are used, the initial transmission may be determined if the received NDI does not correspond to the stored NDI, or the received TB identifier does not correspond to the stored TB identifier. The retransmission may be determined if the received NDI corresponds to the stored NDI and the received TB identifier corresponds to the stored TB identifier.

Taking the above-mentioned SN as an example, the terminal device 110 may interpret the retransmission based on both the NDI value and the SN value. In an example, the DCI may indicate that the UL or DL transmission associated with the DCI is a retransmission if the NDI is not toggled and the SN in the DCI is the same as the stored SN. In another example, the terminal device 110 identifies the UL or DL transmission associated with the DCI as a new transmission if the NDI in the DCI is different from the stored NDI value, and/or if the SN value in the DCI is different from the stored SN value.

An example process is described above with reference to FIG. 2. By means of the TB identifier in DCI, the terminal device can clearly interpret the indication on retransmission and perform the correct combination for HARQ retransmission for downlink transmission.

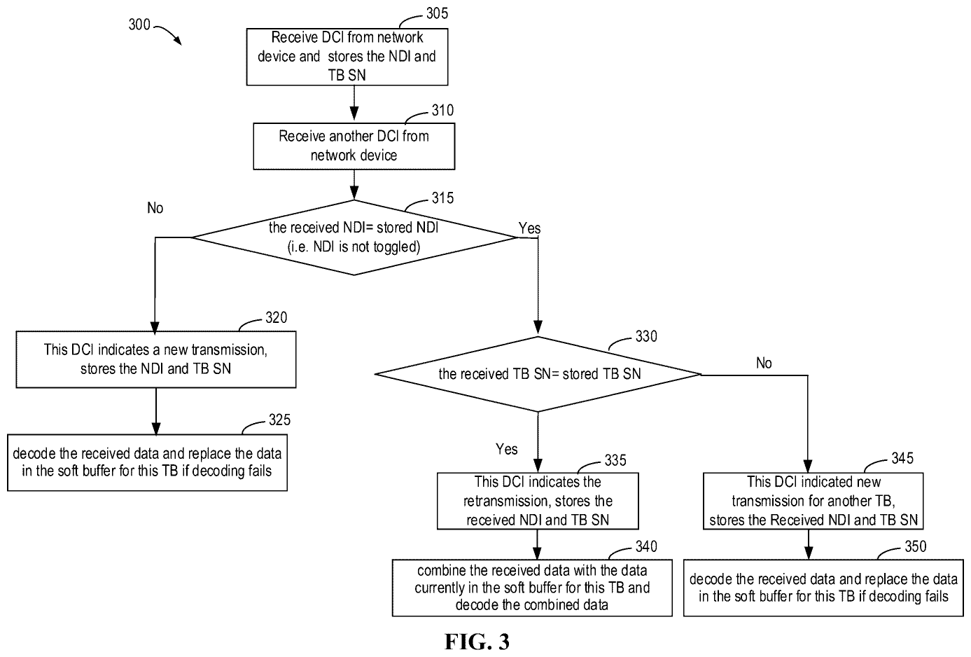

A further example is now described with reference to FIG. 3. FIG. 3 is described by taking the DL transmission as an example. However, this is merely an example without any limitation. The concept can be applied to UL transmission.

As shown in FIG. 3, at block 305, the terminal device 110 receives DCI from the network device 120 and stores the NDI and TB SN comprised in the DCI. At block 310, the terminal device 110 receives another DCI from the network device 120. At block 315, the terminal device 110 determines whether the received NDI equals to a stored NDI. In other words, the terminal device 110 determines whether the NDI is toggled or not.

If the received NDI does not equal to the stored NDI, the process 300 proceeds to block 320. At block 320, the terminal device 110 determines that this DCI indicates a new transmission, and thus stores the NDI and TB SN comprised in the DCI. At block 325, the terminal device 110 decodes the received data and replaces the data in the soft buffer for this TB if decoding of the received data fails.

If the received NDI equals to the stored NDI, the process 300 proceeds to block 330. At block 330, the terminal device 110 determines whether the received TB SN equals to stored TB SN. In more generic terms, the terminal device 110 compares received TB SN with the stored TB SN. The received TB SN may refer to the TB SN comprised in the DCI received in block 310. As noted herein, TB SN may be one example of TB identifier, and the described embodiments with respect to SN may be used also with some other TB identifier.

If the received TB SN equals to stored TB SN, the process 300 proceeds to block 335 from block 330. At block 335, the terminal device 110 determines that the DCI (received in block 310) indicates retransmission. Therefore, the terminal device 110 may proceed to storing the received NDI and TB SN (i.e. those that were received in the DCI of block 310). At block 340, the terminal device 110 combines the received data with the data currently in the soft buffer for the indicated TB and decodes the combined data. Thus, based on the result of the comparing (i.e. result of the comparison performed e.g. at block 330) being that the received TB SN corresponds to the stored TB SN, the terminal device 110 may proceed to block 335 and thus process the indicated TB (i.e. TB with received TB SN) as a retransmission of the TB.

If the received TB SN does not equal to stored TB SN, the process 300 proceeds to block 345. At block 345, the terminal device 110 determines that the DCI (received in block 310) indicates a new transmission of a TB (i.e., transmission of another TB than TB for which TB SN is stored). Further, the terminal device 110 may store the received NDI and TB SN (i.e., those that were received in the DCI of block 310). At block 350, the terminal device 110 decodes the received data and replaces the data in the soft buffer for this TB if decoding the received data fails. Thus, based on the result of the comparing (i.e. result of the comparison performed e.g. at block 330) being that the received TB SN does not correspond to the stored TB SN, the terminal device 110 may proceed to block 345 and thus process the indicated TB (i.e. TB with received TB SN) as an initial transmission of the TB.

With the proposed solution, the terminal device not only compares the NDI value to see if NDI is toggled, but also compares the TB SN (or some other TB identifier that identifies the TB) to see whether it is a retransmission for the same TB. In this way, the terminal device can clearly interpret whether the transmission is associated with the previous TB or a new TB.

To further understand the benefit of the example embodiments, an example case is described as below.
At step 0, a UE successfully receives DCI with NDI=0. The corresponding TB is TB0. The UE does not decode the corresponding PDSCH correctly, i.e., TB0 decoding failure. Then, the stored NDI=0, and the stored TB SN=0.
At step 1, the gNB schedules a new transmission with NDI=1. The corresponding TB is TB1. At step 2, the UE misses the DCI associated with the new transmission with NDI=1. Then, the stored NDI=0, and the stored TB SN=0.
At step 3, the gNB schedules a retransmission with NDI=1. The corresponding TB is TB1. At step 4, the UE still misses the DCI associated with the retransmission with NDI=1. Then, the stored NDI=0, and the stored TB SN=0.
At step 5, the gNB schedules a new transmission with NDI=0. The corresponding TB is TB2. At step 6, the UE receives DCI with NDI=0 and TB SN=2. The UE compares the received NDI (which is equal to 0) with the stored NDI (which is equal to 0), and compares the received SN (which is equal to 2) with the stored TB SN (which is equal to 0). The UE determines that the transmission is for another TB. Then, the combination of received data with stored data will not be performed. In this way, the wrong combination can be avoided.

By introducing the TB identifier (for example, the TB SN) in DCI, the signaling robustness of indicating the retransmission can be improved. With this solution, the retransmission can be indicated through the NDI field and the TB SN field without introducing any additional bits/fields in the DCI and imposing limitations on the network. In particular, this solution can improve the signalling robustness of the retransmission indication if there is DCI/NDI decoding failure while the HARQ feedback for the scheduled HARQ process is disabled.

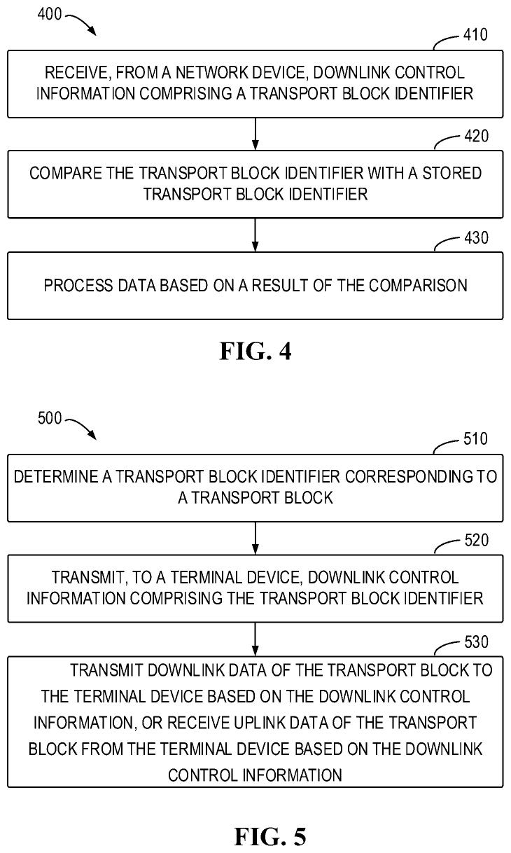

FIG. 4 shows a flowchart of an example method 400 implemented at a terminal device in accordance with some example embodiments of the present disclosure. For the purpose of discussion, the method 400 will be described from the perspective of the terminal device 110 in FIG. 1.

At block 410, the terminal device receives, from a network device, downlink control information comprising a transport block identifier.

At block 420, the terminal device compares the transport block identifier with a stored transport block identifier.

At block 430, the terminal device processes data based on a result of the comparison. The data comprise uplink data to be transmitted based on an uplink grant comprised in the downlink control information or downlink data received based on a downlink assignment comprised in the downlink control information.

In some example embodiments, the downlink control information further comprises a new data indicator. The method 400 further comprises comparing the new data indicator with a stored new data indicator; and in accordance with a determination that the new data indicator corresponds to the stored new data indicator, comparing the transport block identifier with the stored transport block identifier.

In some example embodiments, the data comprise the downlink data. The method 400 further comprises: in accordance with a determination that the transport block identifier does not correspond to the stored transport block identifier, determining the downlink data to be an initial transmission of a transport block corresponding to the transport block identifier; and decoding the downlink data.

In some example embodiments, the data comprise the downlink data. The method 400 further comprises: in accordance with a determination that the transport block identifier corresponds to the stored transport block identifier, determining the downlink data to be a retransmission of a transport block corresponding to the stored transport block identifier; combining the downlink data with stored data for the transport block; and decoding the combined data.

In some example embodiments, the data comprise the uplink data. The method 400 further comprises in accordance with a determination that the transport block identifier does not correspond to the stored transport block identifier, determining the uplink data to be an initial transmission of a transport block corresponding to the transport block identifier; encoding the uplink data for the initial transmission; and transmitting the encoded uplink data to the network device.

In some example embodiments, the data comprise the uplink data. The method 400 further comprises: in accordance with a determination that the transport block identifier corresponds to the stored transport block identifier, determining the uplink data to be a retransmission of a transport block corresponding to the stored transport block identifier; and retransmitting the uplink data to the network device.

In some example embodiments, the transport block identifier comprises a transport block sequence number determined based on: an index of a transport block corresponding to the transport block identifier, and a maximum value of the transport block sequence number.

In some example embodiments, the data comprise the downlink data, and the transport block identifier is comprised in at least one field of: a field for indicating a Hybrid Automatic Repeat reQuest, HARQ-Acknowledgement, ACK, resource, a field for indicating a HARQ-ACK resource offset, a field for a feedback timing indicator, or a field for a new data indicator.

In some example embodiments, the data comprise the uplink data, and the transport block identifier is comprised in a field for a new data indicator.

In some example embodiments, the method 400 further comprises receiving, from the network device, configuration information indicating which one or more fields are used to represent the transport block identifier.

In some example embodiments, the configuration information is received via at least one of: a system information block, a radio resource control signaling, or a medium access control, MAC, control element, CE.

In some example embodiments, which one or more fields are used to represent the transport block identifier is predefined.

In some example embodiments, the transport block identifier is determined per HARQ process.

In some example embodiments, the data comprise the downlink data, and HARQ feedback is disabled.

In some example embodiments, the data comprise the uplink data, and HARQ mode B is enabled.

In some example embodiments, the method further comprises storing the transport block identifier.

FIG. 5 shows a flowchart of an example method 500 implemented at a network device in accordance with some example embodiments of the present disclosure. For the purpose of discussion, the method 500 will be described from the perspective of the network device 120 in FIG. 1.

At block 510, the network device determines a transport block identifier corresponding to a transport block.

At block 520, the network device transmits, to a terminal device, downlink control information comprising the transport block identifier.

At block 530, the network device transmits downlink data of the transport block to the terminal device based on the downlink control information, or receives uplink data of the transport block from the terminal device based on the downlink control information.

In some example embodiments, the downlink control information further comprises a new data indicator.

In some example embodiments, the transport block identifier comprises a transport block sequence number determined based on: an index of the transport block, and a maximum value of the transport block sequence number.

In some example embodiments, the downlink data is transmitted, and the transport block identifier is comprised in at least one field of: a field for indicating a Hybrid Automatic Repeat reQuest, HARQ-Acknowledgement, ACK, resource, a field for indicating a HARQ-ACK resource offset, a field for a feedback timing indicator, or a field for a new data indicator.

In some example embodiments, the uplink data is received, and the transport block identifier is comprised in a field for a new data indicator.

In some example embodiments, the method 500 further comprises transmitting, to the terminal device, configuration information indicating which one or more fields are used to represent the transport block identifier.

In some example embodiments, the configuration information is transmitted via at least one of: a system information block, a radio resource control signaling, or a medium access control, MAC, control element, CE.

In some example embodiments, which one or more fields are used to represent the transport block identifier is predefined.

In some example embodiments, the transport block identifier is determined per HARQ process.

In some example embodiments, the data comprise the downlink data, and HARQ feedback is disabled.

In some example embodiments, the data comprise the uplink data, and HARQ mode B is enabled.

In some example embodiments, an apparatus capable of performing any of the method 400 (for example, the terminal device 110 in FIG. 1) may comprise means for performing the respective operations of the method 400. The means may be implemented in any suitable form. For example, the means may be implemented in a circuitry or software module. The apparatus may be implemented as or included in the terminal device 110 in FIG. 1.

In some example embodiments, the apparatus comprises means for receiving, from a network device, downlink control information comprising a transport block identifier; means for comparing the transport block identifier with a stored transport block identifier; and means for processing data based on a result of the comparison, wherein the data comprise uplink data to be transmitted based on an uplink grant comprised in the downlink control information or downlink data to be received based on a downlink assignment comprised in the downlink control information.

In some example embodiments, the downlink control information further comprises a new data indicator, and the apparatus further comprises: means for comparing the new data indicator with a stored new data indicator; and means for in accordance with a determination that the new data indicator corresponds to the stored new data indicator, comparing the transport block identifier with the stored transport block identifier.

In some example embodiments, the data comprise the downlink data, and the apparatus further comprises: means for in accordance with a determination that the transport block identifier does not correspond to the stored transport block identifier, determining the downlink data to be an initial transmission of a transport block corresponding to the transport block identifier; and means for decoding the downlink data.

In some example embodiments, the data comprise the downlink data, and the apparatus further comprises: means for in accordance with a determination that the transport block identifier corresponds to the stored transport block identifier, determining the downlink data to be a retransmission of a transport block corresponding to the stored transport block identifier; means for combining the downlink data with stored data for the transport block; and means for decoding the combined data.

In some example embodiments, the data comprise the uplink data, and the apparatus further comprises: means for in accordance with a determination that the transport block identifier does not correspond to the stored transport block identifier, determining the uplink data to be an initial transmission of a transport block corresponding to the transport block identifier; means for encoding the uplink data for the initial transmission; and means for transmitting the encoded uplink data to the network device.

In some example embodiments, the data comprise the uplink data, and the apparatus further comprises: means for in accordance with a determination that the transport block identifier corresponds to the stored transport block identifier, determining the uplink data to be a retransmission of a transport block corresponding to the stored transport block identifier; and means for retransmitting the uplink data to the network device.

In some example embodiments, the transport block identifier comprises a transport block sequence number determined based on: an index of a transport block corresponding to the transport block identifier, and a maximum value of the transport block sequence number.

In some example embodiments, the data comprise the downlink data, and the transport block identifier is comprised in at least one field of: a field for indicating a Hybrid Automatic Repeat reQuest, HARQ-Acknowledgement, ACK, resource, a field for indicating a HARQ-ACK resource offset, a field for a feedback timing indicator, or a field for a new data indicator.

In some example embodiments, the data comprise the uplink data, and the transport block identifier is comprised in a field for a new data indicator.

In some example embodiments, the apparatus further comprises: means for receiving, from the network device, configuration information indicating which one or more fields are used to represent the transport block identifier.

In some example embodiments, the configuration information is received via at least one of: a system information block, a radio resource control signaling, or a medium access control, MAC, control element, CE.

In some example embodiments, which one or more fields are used to represent the transport block identifier is predefined.

In some example embodiments, the transport block identifier is determined per HARQ process.

In some example embodiments, the data comprise the downlink data, and HARQ feedback is disabled.

In some example embodiments, the data comprise the uplink data, and HARQ mode B is enabled.

In some example embodiments, the apparatus further comprises: means for storing the transport block identifier.

In some example embodiments, the apparatus further comprises means for performing other operations in some example embodiments of the method 400 or the terminal device 110. In some example embodiments, the means comprises at least one processor; and at least one memory storing instructions that, when executed by the at least one processor, cause the performance of the apparatus.

In some example embodiments, an apparatus capable of performing any of the method 500 (for example, the network device 120 in FIG. 1) may comprise means for performing the respective operations of the method 500. The means may be implemented in any suitable form. For example, the means may be implemented in a circuitry or software module. The apparatus may be implemented as or included in the network device 120 in FIG. 1.

In some example embodiments, the apparatus comprises means for determining a transport block identifier corresponding to a transport block; means for transmitting, to a terminal device, downlink control information comprising the transport block identifier; and means for transmitting downlink data of the transport block to the terminal device based on the downlink control information, or means for receiving uplink data of the transport block from the terminal device based on the downlink control information.

In some example embodiments, the downlink control information further comprises a new data indicator.

In some example embodiments, the transport block identifier comprises a transport block sequence number determined based on: an index of the transport block, and a maximum value of the transport block sequence number.

In some example embodiments, the downlink data is transmitted, and the transport block identifier is comprised in at least one field of: a field for indicating a Hybrid Automatic Repeat reQuest, HARQ-Acknowledgement, ACK, resource, a field for indicating a HARQ-ACK resource offset, a field for a feedback timing indicator, or a field for a new data indicator.

In some example embodiments, the uplink data is received, and the transport block identifier is comprised in a field for a new data indicator.

In some example embodiments, the apparatus further comprises: means for transmitting, to the terminal device, configuration information indicating which one or more fields are used to represent the transport block identifier.

In some example embodiments, the configuration information is transmitted via at least one of: a system information block, a radio resource control signaling, or a medium access control, MAC, control element, CE.

In some example embodiments, which one or more fields are used to represent the transport block identifier is predefined.

In some example embodiments, the transport block identifier is determined per HARQ process.

In some example embodiments, the data comprise the downlink data, and HARQ feedback is disabled.

In some example embodiments, the data comprise the uplink data, and HARQ mode B is enabled.

In some example embodiments, the apparatus further comprises means for performing other operations in some example embodiments of the method 500 or the network device 120. In some example embodiments, the means comprises at least one processor; and at least one memory storing instructions that, when executed by the at least one processor, cause the performance of the apparatus.

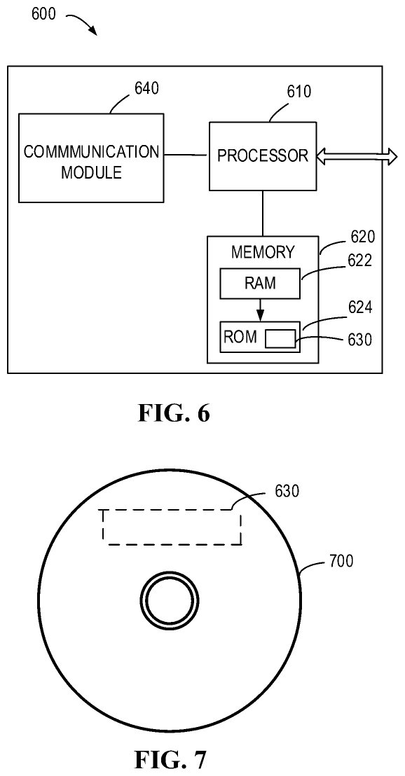

FIG. 6 is a simplified block diagram of a device 600 that is suitable for implementing example embodiments of the present disclosure. The device 600 may be provided to implement a communication device, for example, the terminal device 110 or the network device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
receive, from a network device, downlink control information comprising a transport block identifier;
compare the transport block identifier with a stored transport block identifier; and
process data based on a result of the comparison, wherein the data comprise uplink data to be transmitted based on an uplink grant comprised in the downlink control information or downlink data to be received based on a downlink assignment comprised in the downlink control information.

2. The apparatus of claim 1, wherein the downlink control information further comprises a new data indicator, and the at least one memory storing instructions that, when executed by the at least one processor, further cause the apparatus to:
compare the new data indicator with a stored new data indicator; and
in accordance with a determination that the new data indicator corresponds to the stored new data indicator, compare the transport block identifier with the stored transport block identifier.

3. The apparatus of claim 1, wherein the data comprise the downlink data, and the at least one memory storing instructions that, when executed by the at least one processor, further cause the apparatus to:
in accordance with a determination that the transport block identifier does not correspond to the stored transport block identifier, determine the downlink data to be an initial transmission of a transport block corresponding to the transport block identifier; and
decode the downlink data.

4. The apparatus of claim 1, wherein the data comprise the downlink data, and the at least one memory storing instructions that, when executed by the at least one processor, further cause the apparatus to:
in accordance with a determination that the transport block identifier corresponds to the stored transport block identifier, determine the downlink data to be a retransmission of a transport block corresponding to the stored transport block identifier;
combine the downlink data with stored data for the transport block; and
decode the combined data.

5. The apparatus of claim 1, wherein the data comprise the uplink data, and the at least one memory storing instructions that, when executed by the at least one processor, further cause the apparatus to:
in accordance with a determination that the transport block identifier does not correspond to the stored transport block identifier, determine the uplink data to be an initial transmission of a transport block corresponding to the transport block identifier;
encode the uplink data for the initial transmission; and
transmit the encoded uplink data to the network device.

6. The apparatus of claim 1, wherein the data comprise the uplink data, and the at least one memory storing instructions that, when executed by the at least one processor, further cause the apparatus to:
in accordance with a determination that the transport block identifier corresponds to the stored transport block identifier, determine the uplink data to be a retransmission of a transport block corresponding to the stored transport block identifier; and
retransmit the uplink data to the network device.

7. The apparatus of claim 1, wherein the transport block identifier comprises a transport block sequence number determined based on:
an index of a transport block corresponding to the transport block identifier, and
a maximum value of the transport block sequence number.

8. The apparatus of claim 1, wherein the data comprise the downlink data, and the transport block identifier is comprised in at least one field of:
a field for indicating a Hybrid Automatic Repeat reQuest, HARQ-Acknowledgement, ACK, resource,
a field for indicating a HARQ-ACK resource offset,
a field for a feedback timing indicator, or
a field for a new data indicator.

9. The apparatus of claim 1, wherein the data comprise the uplink data, and the transport block identifier is comprised in a field for a new data indicator.

10. The apparatus of claim 8, wherein the at least one memory storing instructions that, when executed by the at least one processor, further cause the apparatus to:
receive, from the network device, configuration information indicating which one or more fields are used to represent the transport block identifier.

11. The apparatus of claim 10, wherein the configuration information is received via at least one of:
a system information block,
a radio resource control signaling, or
a medium access control, MAC, control element, CE.

12. The apparatus of claim 8, wherein which one or more fields are used to represent the transport block identifier is predefined.

13. The apparatus of claim 1, wherein the transport block identifier is determined per HARQ process.

14. The apparatus of claim 1, wherein the data comprise the downlink data, and HARQ feedback is disabled.

15. The apparatus of claim 1, wherein the data comprise the uplink data, and HARQ mode B is enabled.

16. The apparatus of claim 1, wherein the at least one memory storing instructions that, when executed by the at least one processor, further cause the apparatus to:
store the transport block identifier.

17-27. (canceled)

28. A method comprising:
receiving, at a terminal device from a network device, downlink control information comprising a transport block identifier;
comparing the transport block identifier with a stored transport block identifier; and
processing data based on a result of the comparison, wherein the data comprise uplink data to be transmitted based on an uplink grant comprised in the downlink control information or downlink data to be received based on a downlink assignment comprised in the downlink control information.

29. The method of claim 28, wherein the downlink control information further comprises a new data indicator, and the method further comprises:
comparing the new data indicator with a stored new data indicator; and
in accordance with a determination that the new data indicator corresponds to the stored new data indicator, comparing the transport block identifier with the stored transport block identifier.

30. The method of claim 28, wherein the data comprise the downlink data, and the method further comprises:
in accordance with a determination that the transport block identifier does not correspond to the stored transport block identifier, determining the downlink data to be an initial transmission of a transport block corresponding to the transport block identifier; and
decoding the downlink data.

31. The method of claim 28, wherein the data comprise the downlink data, and the method further comprises:
in accordance with a determination that the transport block identifier corresponds to the stored transport block identifier, determining the downlink data to be a retransmission of a transport block corresponding to the stored transport block identifier;
combining the downlink data with stored data for the transport block; and
decoding the combined data.

32-57. (canceled)
